(19) United States
(12) Patent Application Publication
(10) Pub. No.: US 2007/0047712 A1
(43) Pub. Date: Mar. 1, 2007

(54) SCALABLE, DISTRIBUTED ARCHITECTURE FOR FULLY CONNECTED NETWORK INTERCOM SYSTEM

(75) Inventors: Kevin Paul Gross, Boulder, CO (US); Charles Anderson, Boulder, CO (US); Derek Lieb, Boulder, CO (US)

Correspondence Address: LAW OFFICE OF DAN SHIFRIN, PC - CIRRUS LOGIC, 14081 WEST 59TH AVENUE, ARVADA, CO, 80004, US

(73) Assignee: CIRRUS LOGIC, INC., Austin, CO (US)

(21) Appl. No.: 11/551,674

(22) Filed: Oct. 20, 2006

Related U.S. Application Data
(63) Continuation of application No. 10/384,305, filed on Mar. 7, 2003.

(51) Int. Cl. H04M 9/00; H04M 1/60

(52) U.S. Cl. 379/167.01

(57) ABSTRACT

An intercom system is provided having a plurality of intercom stations coupled to a digital network, each station transmitting intercom data onto a channel of the network. Each station receives intercom data from each other station and selects channels to be amplified and output to a speaker. Each station may listen to and talk to any other station or any selected group of stations. Processing of signals from the network is performed in each station, thereby eliminating the need for a centralized mixing and switching device. Stations may be added merely by connecting them to the network. The intercom system may be configured in a non-blocking mode or in a blocking mode.

### RELATED APPLICATION DATA

The present application is a continuation application of, and claims benefit of, commonly-assigned and co-pending U.S. application Ser. No. 10/384,305, entitled SCALABLE, DISTRIBUTED ARCHITECTURE FOR FULLY CONNECTED NETWORK INTERCOM SYSTEM, filed on Mar. 7, 2003, which application is incorporated herein by reference in its entirety.

### TECHNICAL FIELD

The present invention relates generally to the field of audio mixers and routers and, in particular, to an intercom system in which intercom signals are distributed throughout a digital network and processed locally at each intercom station.

### BACKGROUND ART

Intercom systems may be as simple as two or more with each station being wired directly to each other station. Although such an arrangement permits any station to talk to any other station, a conversation among multiple stations requires extensive switching. Moreover, the number of connections required increases dramatically as the number of stations increases, thereby limiting practical use to a relatively small number of stations in a system.

In larger systems, each station may contribute to and listen to a common audio signal. However, such an arrangement also has limited practical use due to inflexibility, impedance issues, poor sound quality and poor reliability.

Alternatively, each of many stations may be connected to a central routing/switching matrix unit which contains a dense concentration of mixing, switching and processing elements required to implement desired functionality. FIG. 1 illustrates such a system 100. The system 100 includes a number n of intercom stations 102a-102n and a central switching/mixing unit 120. Each station, such as an exemplary intercom station 102n, includes a speaker 112, a microphone 114 and a connector 116 through which the station 102n is connected by cable to the switching/mixing unit 120. Each station may further include one or more user-controlled switches to direct the central unit 120 to connect the station with a selected station or stations. For clarity, other features of the stations, such as amplification and control circuitry, are not illustrated in FIG. 1.

The central unit 120 one mixer module 122a-122n for each intercom station 102a-102n Each mixer module 122 has one input for each corresponding intercom station 102. The microphone 114 of each station, such as intercom station 102n is thus wired through the connector 116 and a connector 124 to an input of each mixer module 122a-122n. The output of each mixer module, such as module 122n, is wired (through the connectors 116 and 124) to the speaker of a single corresponding intercom station, such as intercom station 102n. Disadvantages of such a system include: a central switching unit which is complex and limited in size; cabling which may become expensive and difficult due to the number of interconnects and amount of wire required; and low fault tolerance due to the central switching unit representing a single point of possible failure for the entire intercom system.

Consequently, there remains a need for an intercom system: in which any station is able to talk to or listen to any other station or any combination of other stations (including all of the other stations); which is easily scalable and not unduly limited in size; to and from which stations may be easily added and removed; and which is highly robust and fault-tolerant.

### SUMMARY OF THE INVENTION

The present invention provides an intercom system in which stations are coupled to a digital network, such as an Ethernet network. Each station transmits intercom data, such as digitized audio, onto a channel of the network. Rather than employ a centralized mixing/switching device, each station of the present invention also receives intercom data from each other station and selects channels of other stations with which to communicate. An analog representation of the audio data on the selected channels is audibly output.

Stations may be added up to the bandwidth capacity of the network. However, if the intercom system is configured in a blocking mode, additional stations may be added as long as the number of active stations does not exceed the bandwidth capacity of the network.

Stations may be associated with other stations in preselected zones or groups, thereby allowing for the quick and convenient establishment of communications among the stations in a group.

### BRIEF DESCRIPTION OF THE DRAWINGS

FIG. 1 is a block diagram of a conventional prior art analog intercom system;

FIG. 2 is a block diagram of a digital networked intercom system of the present invention;

FIG. 3A is a block diagram of an exemplary intercom station of the present invention;

FIG. 3B is a block diagram of a microphone and network interface in a non-blocking configuration;

FIG. 3C is a block diagram of a microphone and network interface in a blocking configuration; and

FIG. 4 illustrates an exemplary method of one method for grouping intercom stations.

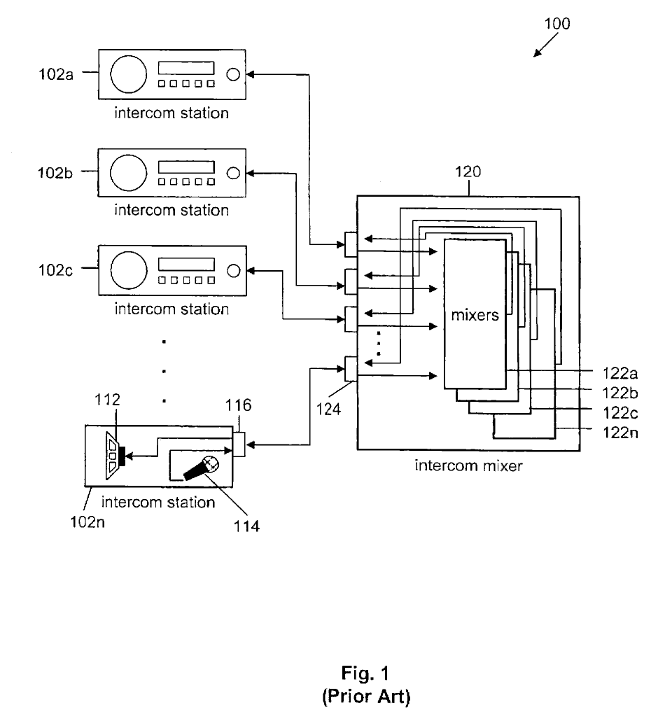

### DETAILED DESCRIPTION OF THE PREFERRED EMBODIMENT

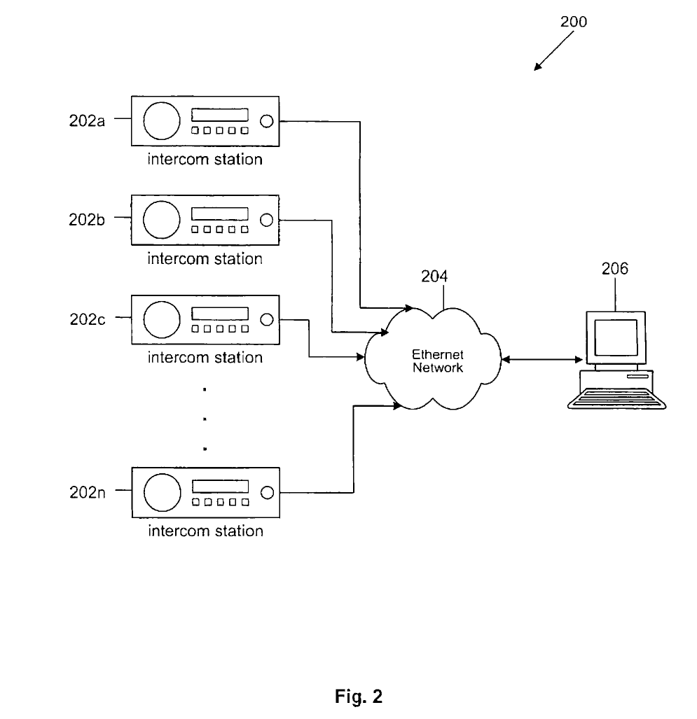

FIG. 2 is a block diagram of a digital networked intercom system 200 of the present invention. The system includes a number n of intercom stations 202a-202n, each connected to a digital network 204, such as an Ethernet network, through an appropriate communications medium, such as cabling or a wireless network. An optional computer, such as a PC 206, may also be connected to the network 204 to provide configuration management as will be described below. One network architecture on which the present invention may be employed has been developed by the Peak Audio division of Cirrus Logic, Inc. and is an audio network technology marketed under the name and trademark CobraNet™. CobraNet technology allows data, such as uncompressed, real-time, single- or multiple-channel digital audio, clocking and control data, to be transmitted over an Ethernet network. Audio sources, signal processing, amplification and sound projection may be distributed throughout a system, all interconnected by Ethernet CAT-5 or optical cabling. Thus, any (single or multiple) audio input may be routed to any (single or multiple) audio output, with each input and each output being capable of being individually processed and amplified.

When connected to a 100Base-T Ethernet network, the intercom system 200 may typically accommodate up to sixty-four stations, each transmitting one channel of high quality intercom audio (20-bit resolution at a 48 kHz sample rate). Convenient RJ-45 connectors and CAT-5 unshielded twisted pair cable may be used to interconnect the stations 202 with the network 204. When optical fiber is used, the intercom system may have a communication range of up to about two kilometers (2 km). A digital network significantly reduces electrical interference and, when optical cable is used, electrical interference may almost be eliminated entirely. Thus, the intercom system 200 of the present invention provides a more robust system with higher quality audio than prior art systems.

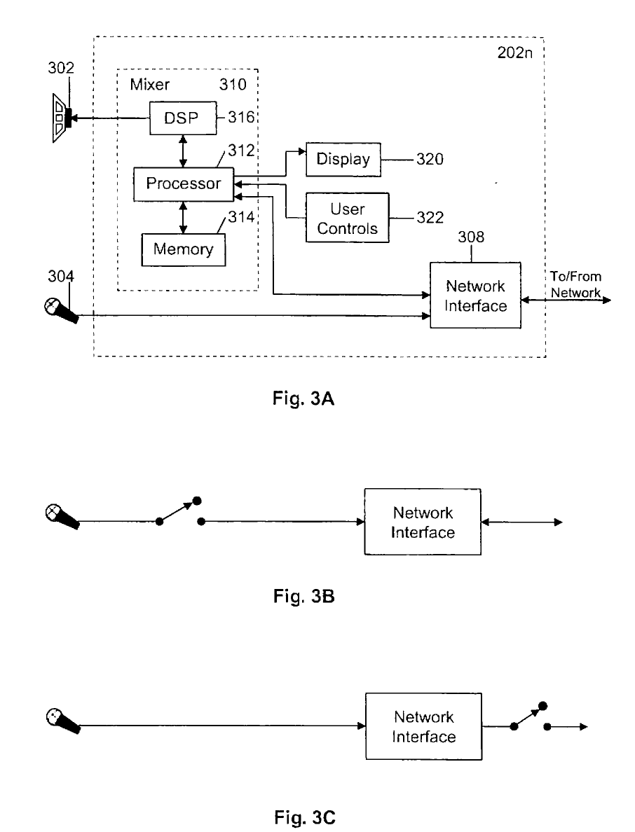

FIG. 3A is a block diagram of an exemplary intercom station 202n of the present invention. The intercom station 202n includes an audio output, such as a speaker 302, an audio input, such as a microphone 304, a mixer 310 and a network interface 308 through which the station 202n connects to the network 204. The station 202n also preferably includes a display 320 and user controls 322 to provide enhanced functions. The station 202n may also include such signal processing devices as automatic gain control and equalization (not shown) to improve audio input and/or output quality. An intercom station may alternatively be configured as a transmit-only station or as a receive-only station.

The mixer 310 includes a processor or other control device 312, a memory device 314 and a digital signal processor (DSP) 316. The speaker 302 is coupled to an output of the DSP 316. The memory device 314, DSP 316, display 320 and user controls 322 are coupled to the processor 312. The processor 312 and microphone 304 are coupled to the network interface 308. The processor 312 may be incorporated as part of the DSP 316 or may be implemented as a separate device. Similarly, the memory device 314 may be combined with other components or may be separate. The scope of the present invention is not limited to any particular circuit arrangement within the mixer 310.

In one embodiment (FIG. 3B), the intercom system 200 is in a “non-blocking” configuration in which all stations 202a-202n continuously transmit a channel signal to the network 204. A switch 324 may be used to enable and disable a station's microphone 304, thereby selectively muting/unmuting the audio signal which is added to the station's continuous channel signal. In another embodiment (FIG. 3C), the intercom system 200 is in a “blocking” configuration in which an intercom station only transmits a channel signal to the network 204 when its audio signal is desired to be placed on the network 204. A switch 326 may be used to enable and disable a station's channel signal. A blocking system may be used to increase the number of stations beyond the normal bandwidth capacity of the network 204. For example, if the bandwidth of the network 204 is normally sixty-four channels, no more than sixty-four stations may be connected to the network 204 in a non-blocking configuration. However, if the system 200 is configured as a blocking system, more than sixty-four stations 202 may be connected to the network 204. Such connections are permitted as long as no more than sixty-four stations 202 transmit a signal to the network 204 at any one time (that is, as long as no more than sixty-four channels are active on the network 204 at any one time).

In operation, the microphone 304 sends an audio signal to the network interface 308 which transmits a digital audio signal as a station channel multiplexed with channels from other active intercom stations onto the network 204. Conventional circuitry may be used to convert an analog audio signal from the microphone 304 into a digital signal for transmission onto the network 204. As noted above, in a non-blocking configuration, the network interface 308 sends a continuous signal onto the network 204; in a blocking configuration, the channel signal transmitted by the interface 308 is selectively enabled and disabled.

The interface 308 of the station 202n also receives a digital signal from the network 204 which contains the digital audio signals, in multiplexed format, from each other active channel from other stations 202a-c. Although an intercom station may be configured so that the user is not able to change the station(s) with which the station communicates, the station 202n preferably includes the display 320 and controls 322 by which a user may select which station(s) with which to communicate. Under the control of the processor 312 (taking commands from the user controls 322), the DSP 316 selects which of the audio channels in the network signal to include in the output; the remainder of the audio channels in the network signal are effectively muted. The resulting digital audio signal is converted into an analog audio signal (again by conventional means) and output to the speaker 302 for listening by the user. Thus, a user may communicate with any other station(s) even while users of other stations are communicating among themselves.

Preferably, each intercom station also includes means for selecting several other stations with which to communicate simultaneously as a group. For example, in a theater setting, the director may need to converse separately with: the sound manager, the lighting manager, the stage hands, the prop manager and the dressing room personnel. To avoid distractions, however, it is not desired for the sound and lighting managers to hear, for example, the director's conversations with the stage hands. Consequently, the intercom stations (and their corresponding network channels) relating to each of the five listed categories may be designated as a separate group, easily selectable by the director or by anyone else.

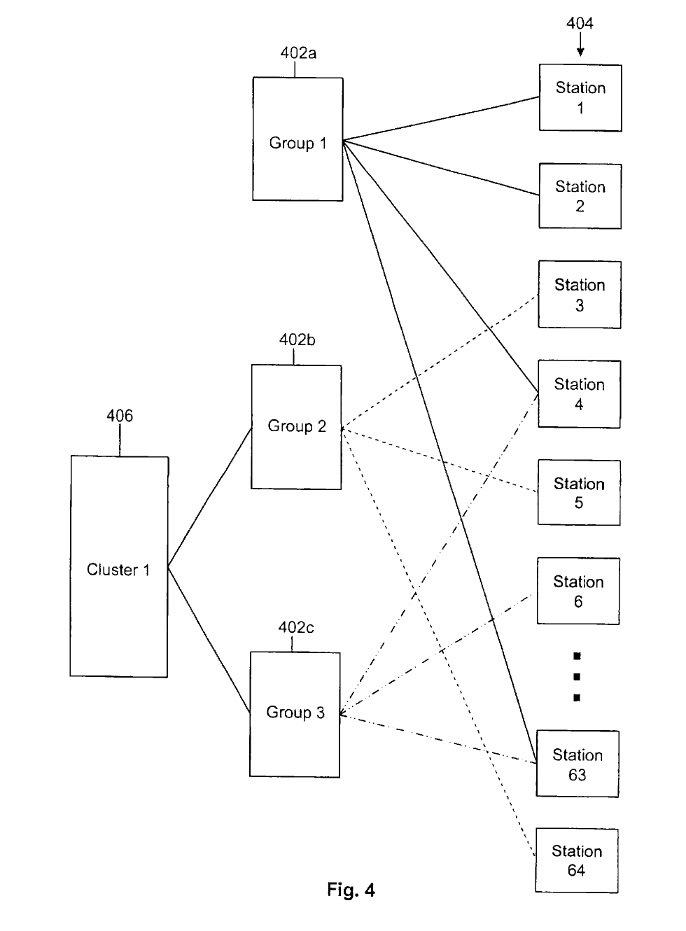

In one embodiment, a computer, such as the PC 206 of FIG. 2, is connected to the network 204 and used to establish station groups. FIG. 4 illustrates one method by which an operator of the computer 206 may select intercom stations. Boxes or icons may be selected to represent the groups (such as the box identified as 402a representing Group 1). Then, individual intercom stations 404 may be selected (such as by extending a line or by dragging and dropping) to be part of a group. A group may be as small as a two stations or as large as all of the stations. Stations may be part of more than one group and two or more groups, such as Group 2 402b and Group 3 402c, may be associated as a “cluster” 406, making the establishment of groups more convenient. Once groups have been selected, the configuration may be saved and transmitted to each station to be stored in the memory 314. Stations may be easily added or removed from any group as needed or as stations are added or removed from the system 200. When a user at a station wants to begin a conversation with users at other stations in a group, the initiating user selects the desired group using the controls 322. The processor 312 then directs the DSP 316 to select the channels of those stations in the selected group and also sends a signal through the interface 308 to each other station in the group, analogous to a “call” signal. The call signal causes the processors of each of the other stations in the group to direct the corresponding DSP to select the channels of the stations in the group. Thus, by communicating with other processors, a processor 312 may cause communications paths to be opened among all of the stations in the selected group.

Because switching and mixing is performed independently at each intercom station 202, no single point of failure exists in the intercom system 200. Moreover, the system 200 is fully scalable in that, unlike some conventional systems with centralized switching and mixing, no minimum number of stations is required to be connected. The maximum number of stations is limited by the bandwidth of the network 204. However, the maximum number may be increased by using a blocking configuration or increasing the network bandwidth. The maximum number may also be increased by reducing the quality of the audio signal from 20-bit resolution at a 48 kHz sample rate to, for example, 16-bit resolution at a 32 kHz sample rate.

In another embodiment, video signals (or audio and video signals) may be exchanged over a network with a display screen at each intercom station having separate display windows open for each station with which a station is communicating.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

What is claimed is:

1. An intercom system, comprising:
a CobraNet-based digital network over which digital audio, clocking and control data are transmittable; and
a plurality of intercom stations, each comprising:
a source of digital intercom data;
a network transmitter coupled to transmit the digital intercom data onto the digital network;
a network receiver coupled to receive a digital signal comprising digital intercom data from other intercom stations and clocking data from a designated master network clock;
a selector operable to select digital intercom data from one or more other intercom stations to be output; and
a mixer operable to combine the selected digital intercom data into an output.

2. The intercom system of claim 1, wherein the selector selects digital intercom data from a single one of the other intercom stations to be output.

3. The intercom system of claim 1, wherein the selector selects digital intercom data from a predefined group of the other intercom stations to be output.

4. The intercom system of claim 1, wherein the digital intercom data comprises digital audio data.

5. The intercom system of claim 1, wherein the digital intercom data comprises digital video data.

6. The intercom station of claim 1, wherein the mixer comprises a multi-channel DSP module.

7. The intercom station of claim 1, further comprising a switch operable to selectively disable transmission of digital intercom data from the audio source to the network such that the intercom station operates in a non-blocking mode.

8. The intercom station of claim 1, further comprising a switch operable to selectively disable transmission of digital intercom data from the transmitter to the digital network such that the intercom station operates in a blocking mode.

9. A method for communicating among intercom stations, comprising:
connecting a first intercom station and a plurality of other intercom stations, including a second intercom station, directly to a CobraNet-based digital network;
transmitting digitized audio data from the first intercom station onto the digital network;
receiving at the second intercom station a digital signal from the digital network comprising digitized audio data from at least the first intercom station and clocking data from a designated master network clock;
selecting at the second intercom station digitized audio data from at least the first intercom station from which to output an audio signal;
mixing at the second intercom station the selected digitized audio data from the selected intercom stations into a mixed analog audio signal; and
audibly outputting the mixed audio signal at the second intercom station.

10. The method of claim 9, further comprising transmitting a call signal from the first intercom station onto the digital network directed to one or more other intercom stations, whereby communications paths are established among the first intercom station and the one or more other intercom stations.

11. The method of claim 9, wherein selecting comprises selecting at the second intercom station a predefined group of other intercom stations from which to output an audio signal.

12. The method of claim 9, further comprising receiving digital programming signals from a network controller establishing a predetermined group of intercom stations.

13. The method of claim 9, wherein the first station continually transmits a digital signal onto the digital network in a non-blocking mode.

14. The method of claim 9, wherein the first intercom station transmits a digital signal onto the digital network in a blocking mode only when communications with another intercom station is desired.

15. The method of claim 9, wherein mixing comprises processing the selected digitized audio data through a multi-channel DSP module.

16. An intercom station, comprising:
an audio source;
a converter operable to convert a signal from the audio source into a digital audio sigAnal;
a network transmitter coupled to transmit the digital audio signal onto a CobraNet-based digital network;
a network receiver coupled to receive a digital signal comprising digital audio signals from one or more other intercom stations and clocking data from a designated master network clock;
a selector, coupled to the receiving circuitry, for selecting digital audio signals from at least one other station to be audibly output; and
a mixer, responsive to the selector, for generating a mixed audio signal from the selected digital audio signals to be audibly output.

17. The intercom station of claim 16, wherein the selector is operable to select a predefined group of the digital audio signals to be audibly output.

18. The intercom station of claim 16, further comprising a user-operated switch, coupled to the selector, for selecting which of the digital audio signals from the at least one other station are to be audibly output.

19. The intercom station of claim 16, further comprising call circuitry operable to send a call signal from the intercom station to any other selected intercom stations.

20. The intercom station of claim 16, further comprising a programming unit, interconnected to the network, for transmitting digital programming signals to selected stations to establish a predetermined group of stations.

21. The intercom station of claim 16, wherein the mixer comprises a multi-channel DSP module.

22. The intercom station of claim 16, further comprising a switch operable to selectively disable transmission of an audio signal from the audio source to the network such that the intercom station operates in a non-blocking mode.

23. The intercom station of claim 16, further comprising a switch operable to selectively disable transmission of a digital audio signal from the transmitter to the digital network such that the intercom station operates in a blocking mode.
